(19) United States
(12) Patent Application Publication
(10) Pub. No.: US 2020/0167016 A1
(43) Pub. Date: May 28, 2020

(54) ELECTRONIC DEVICE AND METHOD OF TRANSMITTING DATA BY ELECTRONIC DEVICE

(71) Applicant: Samsung Electronics Co., Ltd., Gyeonggi-do (KR)

(72) Inventors: Sungchull LEE, Gyeonggi-do (KR); Jaemyung LEE, Gyeonggi-do (KR); Geunyoung CHOI, Gyeonggi-do (KR)

(73) Assignee: Samsung Electronics Co., Ltd.

(21) Appl. No.: 16/669,041

(22) Filed: Oct. 30, 2019

(30) Foreign Application Priority Data
Nov. 28, 2018 (KR) 10-2018-0149481

(51) Int. Cl. G06F 3/044; G06F 3/0488; G06F 3/0354; H04L 12/851; H04L 12/801

(52) U.S. Cl. CPC G06F 3/044; G06F 3/04883; H04L 47/14; G06F 3/03547; H04L 47/2433; G06F 3/04886

(57) ABSTRACT

An electronic device includes a housing, a touch screen display exposed through a portion of the housing, at least one communication module located inside the housing, a processor located inside the housing and operatively connected to the touch screen display and the at least one communication module, and a memory located inside the housing and operatively connected to the processor, wherein the memory is configured to store at least one of personal data and a priority table having priority information of each data type, and store instructions causing the processor, when executed, to establish a connection with an external electronic device by the electronic device through the communication module, transmit the priority table of the electronic device to the external electronic device in response to the established connection, and receive data transmitted from the external electronic device based on at least a portion of the priority table of the electronic device through the communication module.

### CROSS-REFERENCE TO RELATED APPLICATION(S)

This application is based on and claims priority under 35 U.S.C. § 119 to Korean Patent Application No. 10-2018-0149481, filed on Nov. 28, 2018, in the Korean Intellectual Property Office, the disclosure of which is incorporated by reference herein in its entirety.

### BACKGROUND

### 1. FIELD

The disclosure relates generally to an electronic device and a method of transmitting data by an electronic device.

### 2. DESCRIPTION OF RELATED ART

A biometric information measurement device (for example, a wearable device, a band, or a scale) may uni-directionally transmit or exchange simple health data (for example, profile, step count, or sleep information of a user) to or with an electronic device.

A biometric information measurement device to which a health management function has been recently added increases the amount of health data (for example, water data, caffeine data, sleep data, stress data, food data, weight data, and step count data) provided to an electronic device and provides real time health information to the electronic device.

Most health data provided by a biometric information measurement device, to which a health management function is added, contains vast amounts of raw data for accurate analysis and thus the biometric information measurement device may provide a very large amount of health data.

A time required to process each piece of the data may increase due to the large amount of health data, and it may also take time to cut, process, and transmit partial data according to a method of transmitting a table including health data among measurement, storage, synchronization, processing, and transmission processes. It is important to transmit optimized data to allow a user to experience a process in almost in real time.

The health data should pass through an encryption/decryption process for security; thus, it may take a longer time to transmit the health information. When the user exercises while using a positioning system (for example, a global positioning system (GPS)) included in the biometric information measurement device, or when the user has not synchronized health information between the biometric information measurement device and the electronic device for a long time, the user may be inconvenienced in that the user must wait a long time until the electronic device receives and identifies the health data measured by the biometric information measurement device.

For example, in order to check whether there is something wrong with a heart rate after exercising for a long time, a biometric information measurement device may measure a user's heart rate and a health application of the electronic device may check the same. However, the biometric information measurement device may synchronize raw data (i.e., measured position data, step count data, or altitude data according to the exercise) with heart rate data and transmit the synchronized data to the electronic device. Thus, the user may have to wait a long time to see his or her heart rate data since the heart rate data is transmitted together with other raw data even though the heart rate data itself is low in volume.

In the case of an application programming interface (API) provided in a framework layer for data transmission between devices in the latest operating system (OS), an option indicating urgency of data transmission is configured by a client application and a part for dynamically changing data transmission is not supported by the framework layer.

Further, a scheme through which data is transmitted between devices in the client application groups data from the last time point at which a table including data is transmitted to the present time into one packet and transmits the one packet, and when an amount of data in the packet exceeds a maximum transmission range, separates the packet and transmits the separated packets together. However, the data transmission scheme has a disadvantage in that the processing requirements necessary for performing the scheme rapidly increase as an amount of health data measured by various biometric information measurement devices increases.

### SUMMARY

The present disclosure has been made to address the above-mentioned problems and disadvantages, and to provide at least the advantages described below.

In accordance with an aspect of the disclosure, an electronic device is provided. The electronic device includes a housing, a touch screen display exposed through a portion of the housing, at least one communication module located inside the housing, a processor located inside the housing and operatively connected to the touch screen display and the at least one communication module, and a memory located inside the housing and operatively connected to the processor, wherein the memory is configured to store at least one of personal data and a priority table having priority information of each data type, and store instructions causing the processor, when executed, to, establish a connection with an external electronic device by the electronic device through the communication module, transmit the priority table of the electronic device to the external electronic device in response to the established connection, and receive data transmitted from the external electronic device through the communication module based on at least a portion of the priority table of the electronic device.

In accordance with another aspect of the disclosure, a method of transmitting data by an electronic device is provided. The method includes storing at least one of personal data and a priority table having priority information for each data type, establishing a connection with an external electronic device by the electronic device, transmitting the priority table of the electronic device to the external electronic device in response to the established connection, and receiving data transmitted from the external electronic device based on at least a portion of the priority table of the electronic device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram illustrating an electronic device within a network environment, according to an embodiment;

FIG. 1B illustrates the appearance of an electronic device, according to an embodiment;

FIG. 2 is a block diagram illustrating a first electronic device and a second electronic device, according to an embodiment;

FIG. 3 illustrates a default priority table provided by a server, according to an embodiment;

FIG. 4 is a personalized priority table provided by an electronic device, according to an embodiment;

FIG. 5A illustrates an operation in which the electronic device displays data, according to an embodiment;

FIG. 5B illustrates an operation in which the electronic device displays data, according to an embodiment;

FIG. 5C illustrates an operation in which the electronic device displays data, according to an embodiment;

FIG. 5D illustrates an operation in which the electronic device displays data, according to an embodiment;

FIG. 5E illustrates an operation in which the electronic device displays data, according to an embodiment;

FIG. 6 illustrates an operation in which the electronic device transmits data, according to an embodiment;

FIG. 7A illustrates an operation in which the electronic device transmits data, according to an embodiment;

FIG. 7B illustrates an operation in which the electronic device transmits data, according to an embodiment;

FIG. 8A illustrates a plurality of communication means through which the electronic device transmits data, according to an embodiment;

FIG. 8B illustrates a plurality of communication means through which the electronic device transmits data according to an embodiment;

FIG. 8C illustrates a plurality of communication means through which the electronic device transmits data, according to an embodiment;

FIG. 9 illustrates an operation for exchange of priority tables between electronic devices, according to an embodiment;

FIG. 10A illustrates an operation in which the electronic device transmits data based on a priority, according to an embodiment,

FIG. 10B illustrates an operation in which the electronic device transmits data based on a priority, according to an embodiment;

FIG. 11 is a flowchart illustrating a data transmission operation of the electronic device, according to an embodiment;

FIG. 12A is a flowchart illustrating a data transmission operation of the electronic device, according to an embodiment,

FIG. 12B is a flowchart illustrating a data transmission operation of the electronic device, according to an embodiment;

FIG. 13A is a flowchart illustrating a data transmission operation of the electronic device, according to an embodiment;

FIG. 13B is a flowchart illustrating a data transmission operation of the electronic device, according to an embodiment;

FIG. 14A is a flowchart illustrating a data transmission operation of the electronic device, according to an embodiment;

FIG. 14B is a flowchart illustrating a data transmission operation of the electronic device, according to an embodiment; and

FIG. 15 is a flowchart illustrating a data transmission operation of the electronic device, according to an embodiment.

### DETAILED DESCRIPTION

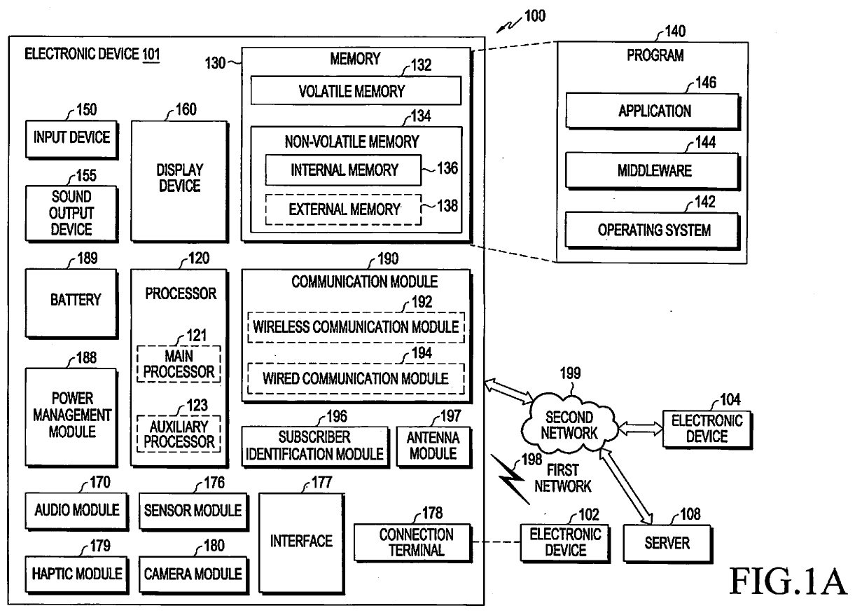

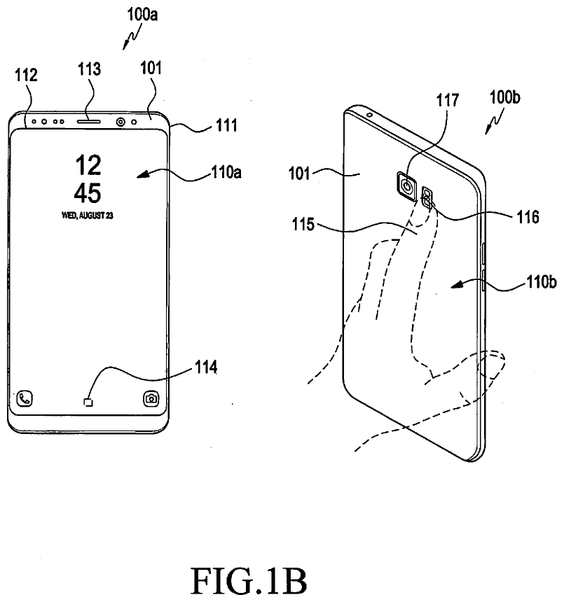

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing recordings, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 1B illustrates examples 100a and 100b of the appearance of an electronic device, according to an embodiment.

FIG. 1B shows the front appearance 100a and the back appearance 100b of an electronic device 101. Referring to FIG. 1B, the electronic device 101 includes a housing 111, a display 112, or a speaker 113.

The housing 111 may provide a space for receiving an element (for example, the display 112 or the speaker 113). The housing 111 may be implemented in various forms.

The display 112 may be located on a front surface 110a of the housing 111. The display 112 may be a touch-screen type that overlaps a touch panel. The display 112 may include a curved surface. For example, the display 112 may include a curved surface in an edge area close to a corner.

The speaker 113 for outputting a voice signal may be located above the display 112 disposed on the front surface 110a of the housing 111. A home key 14 in a soft-key type may be located in a display area on the lower part of the display 112.

The electronic device 101 may mount components for performing various functions. The components may include at least one sensor module that includes a configuration which is the same as or similar to the sensor module 176. For example, at least one of an illumination sensor (i.e., an optical sensor), a proximity sensor, an infrared sensor, or an ultrasound sensor may be disposed in the vicinity of the speaker 113. Further, the sensor module may include a motion sensor, such as a gyro sensor or a geomagnetic sensor, as well as an acceleration sensor and may acquire information on a user's motion related to activities of the user of the electronic device 101. The sensor module may include at least one biometric sensor (for example, a heart rate sensor) for measuring a user's biometric information.

A biometric sensor 116 may be disposed on the back surface 110b of the electronic device 101 (for example, the surface facing a direction opposite the display 112). The biometric sensor 116 may be disposed adjacent to the camera module 117. A fingerprint sensor may be disposed on the back surface 110b of the electronic device 101 separately from the biometric sensor 116. Further, the fingerprint sensor may be mounted on the side surface of the electronic device 101 or inside the display 112 disposed on the front surface 110a. For example, when the fingerprint sensor is disposed on the side surface of the electronic device 101, the user may easily touch the fingerprint sensor with a thumb while grasping the electronic device 101 as illustrated in the example of the back appearance 100b of the electronic device 101 in FIG. 1B.

Fingerprint information may be acquired in the state in which the user grasps the electronic device 101 with his/her hand. Accordingly, if the number of users using the electronic device 101 is plural, the users may be identified on the basis of input fingerprint information. Therefore, the electronic device 101 may manage data related to each user on the basis of biometric information of a plurality of users or a signal for identifying biometric information.

The biometric information or the signal for identifying the biometric information may be acquired by bringing a user's body part 115 (for example, a finger) into contact with the biometric sensor 116 or making the user's body part 115 close to the biometric sensor 116. The biometric information or the signal for identifying the biometric information may be acquired according to the position of the biometric sensor 116 in the electronic device 101.

The electronic device 101 may acquire at least one piece of sensor data generated according to movement of the user through at least one sensor included in the sensor module. The electronic device 101 may determine a user's action state (for example, an exercise state or a sleep state) on the basis of at least one piece of the acquired sensor data. For example, the electronic device 101 may identify the user's action state (i.e., squatting, running, swimming, cycling, walking, or hiking) on the basis of at least one piece of sensor data acquired by the sensor module. The electronic device 101 may interwork (i.e., connect) with a wearable electronic device such as a wearable device or a health band to acquire data related to the user's action. When the electronic device 101 interworks with the wearable device, the electronic device 101 may acquire data related to the user's action from the wearable device.

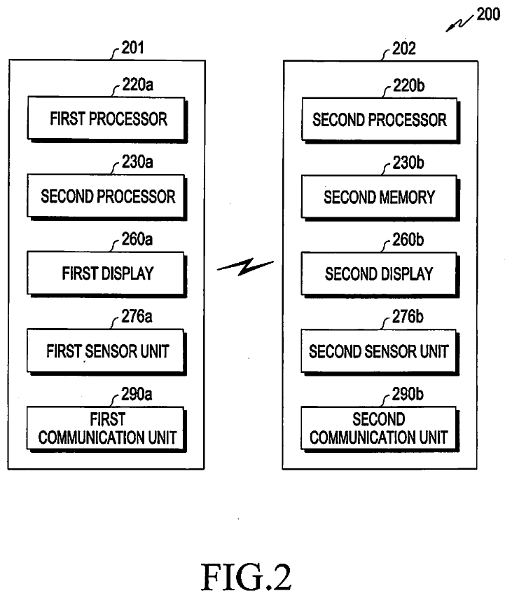

FIG. 2 is a block diagram 200 illustrating a first electronic device 201 and a second electronic device 202, according to an embodiment. The first electronic device 201 and the second electronic device 202 may include all or some of the electronic device 101 illustrated in FIG. 1A.

Referring to FIG. 2, the first electronic device 201 includes a first processor 220a, a first memory 230a, a first display 260a, a first sensor unit 276a, and a first communication unit 290a.

The first processor 220a may store a priority table of the first electronic device 201 having priority information for each type of data.

The first processor 220a may receive a default priority table corresponding to user profile information of the first electronic device 201 from a server 108 and configure the default priority table as the priority table of the first electronic device.

The first processor 220a may provide user profile information (for example, age, height, weight, and gender) input by the user of the first electronic device 201 through a health application to the server 108 and receive the default priority table corresponding to the user profile information of the first electronic device 201 among a plurality of priority tables stored in the server 108.

The server 108 may collect data (for example, exercise data, sleep data, step count data, and stress data) from users of a plurality of electronic devices, generate a priority table including priority information for each type of data on the basis of at least a portion of the collected data, and classify the generated priority table into a plurality of priority tables on the basis of at least a portion of the user profile information. The server 108 may transmit the default priority table corresponding to the user profile information of the first electronic device 201 among the plurality of priority tables according to a request from the first electronic device 201.

For example, a female user in her 50s may receive a default priority table in which blood sugar data and/or diabetic data has a high priority (i.e., a high priority value) on the basis of a portion of user profile information configured by the user among the plurality of priority tables stored in the server. The received default priority table may be configured as the priority table of the first electronic device 201 without any additional configuration. Alternatively, a male user in his 30s may receive a default priority table in which data related to exercise has a high priority on the basis of at least a portion of user profile information configured by the user among the plurality of priority tables stored in the server. The received default priority table may be configured as the priority table of the first electronic device 201 without any additional configuration.

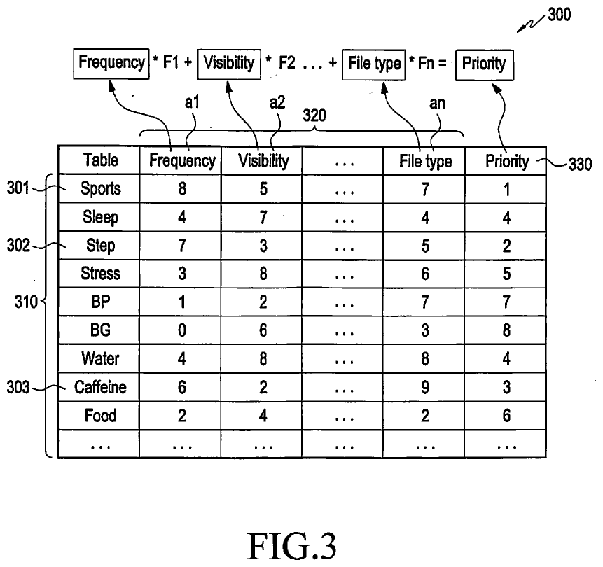

Further, the default priority table may include the data type and a priority score for each data type. The priority score for each data type may be identified on the basis of scores of priority determination data (for example, frequency, visibility, or file type). With regard to the visibility of the priority determination data, a high score may be assigned to a data type that is frequently exposed to a dashboard of the health application or a data type of a tracker that is used by the user recently. With regard to the file type of the priority determination data, a high score may be assigned to a file type having a large size, a normal value file type or a summary file type, rather than the high score being assigned to a raw data type such as a positioning system (for example, a GPS). In FIG. 3, the default priority table provided by the server 108 will be described.

FIG. 3 illustrates a default priority table 300 provided to the server, according to an embodiment. FIG. 3 shows an example of a default priority table corresponding to a male user in his 20s among a plurality of priority tables.

Referring to FIG. 3, the default priority table 300 includes a data type 310, a priority determination data type 320, and a priority score 330 for each data type. The server 108 may determine the priority score 330 for each data type by multiplying each score of the priority determination data 320 (for example, frequency a1, visibility a2, . . . , and file type an) and a predetermined scale factor value (for example, F1, F2, . . . , and Fn) and summing (i.e., adding) all the priority score determination data 320 multiplied by the predetermined scale factor value. As illustrated in FIG. 3, the male user in his 20s receiving the default priority table 300, in which sports data 301 and step count data 302 have a high priority, may configure the default priority table 300 as the priority table of the first electronic device 201 without any additional configuration.

The first processor 220a may periodically (for example, daily) receive a default priority table 300 corresponding to user profile information of the first electronic device 201 from the server 108 and update the priority table of the first electronic device 201 on the basis of at least a portion of the received default priority table 300.

The first processor 220a may generate a personalized priority table on the basis of the default priority table 300 received from the server 108 and/or at least a portion of personal data stored in the first memory 230a in response to a selection of generating the personalized priority table, and configure the generated personalized priority table as the priority table of the first electronic device 201.

The first processor 220a may determine a selection of generating the personalized priority table in response to selection by the user or a preset option value.

When generation of the personalized priority table is selected, the first processor 220a may generate a personalized priority table changed from priority information (for example, the priority score 330 for each data type of FIG. 3) of the default priority table 300 corresponding to user profile information of the first electronic device 201 received from the server 108 on the basis of at least a portion of personal data collected by the first electronic device 201 and stored in the first memory 230a. The personal data stored in the first memory 230a may be a score (for example, the score of the priority determination data 320 of FIG. 3) of a frequency, visibility, and/or a file type corresponding to the data type used by the user of the first electronic device 201.

When the priority information 330 configured in the default priority table 300 received from the server 108 should be changed on the basis of at least a portion of the personal data stored in the first memory 230a, the first processor 220a may generate a personalized priority table in which at least one of the data type in the default priority table 300 and the data type determined on the basis of at least a portion of the personal data stored in the first memory 230a has high priority.

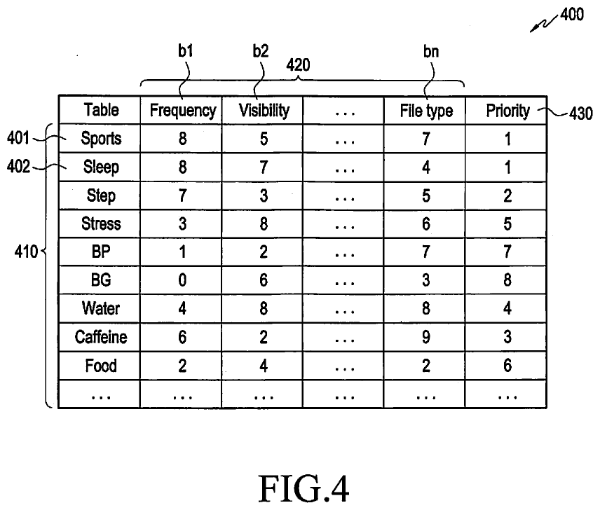

For example, when a female user in her 50s receives a default priority table 300, in which blood sugar data and/or diabetic data has the high priority, from the server 108 and frequently uses the data type related to exercise on the basis of an analysis result of personal data stored in the electronic device in response to a selection of generating the personalized priority table, a priority of exercise-related data as well as the blood sugar data and/or the diabetic data may increase. In FIG. 4, the personalized priority table provided by the first electronic device 201 will be described.

FIG. 4 illustrates a personalized priority table 400 provided by the electronic device, according to an embodiment. FIG. 4 shows an example of a personalized priority table corresponding to a male user in his 20s.

Referring to FIG. 4, the personalized priority table 400 includes a data type 410, a priority determination data type 420, and a priority score 430 for each data type 410. The first processor 220a may analyze personal data stored in the first memory 230a in response to a selection of generating the personalized priority table. The first processor 220a may identify the priority score 430 for each type data on the basis of at least a portion of personal data. The first processor 220a may determine the priority score 430 for each data type by multiplying each score of the priority determination data 420 (for example, frequency b1, visibility b2, . . . , and file type bn) and a predetermined scale factor value (for example, F1, F2, . . . , and Fn) and summing (i.e., adding) all the priority score determination data 420 multiplied by the predetermined scale factor value.

Sports data 401 is identified as a data type having the high priority (i.e., high or highest priority value) in the default priority table 300 based on the identification result of the priority score 430 for each data type on the basis of at least a portion of the personal data. In addition, sleep data 402 is determined as a data type having high priority on the basis of at least a portion of the personal data stored in the first memory 230a. The first processor 220a may generate the personalized priority table 400 in which the sports data 401 and the sleep data 402 have the highest priorities (i.e., sports data 401 and sleep data 402 both have the highest priority value). Alternatively, the first processor 220a may determine that the sleep data 402 has the highest priority (i.e., highest priority value) and the sports data 401 has the next highest priority (i.e., next highest priority value).

The first processor 220a may periodically update the priority table of the first electronic device 201 corresponding to the personalized priority table 400 on the basis of at least a portion of a change in the personal data stored in the first memory 230a.

The first processor 220a may transmit the personalized priority table 400 configured as the priority table of the first electronic device 201 to the server 108 in order to allow the server 108 to register the personalized priority table 400 as a user priority table of the first electronic device 201.

When cancelling the generation of the personalized priority table 400 is selected while the personalized priority table 400 is configured as the priority table of the first electronic device 201, the first processor 220a may configure the default priority table 300 received from the server 108 as the priority table of the first electronic device 201.

The first processor 220a may classify the data types 410 according to each transmission level on the basis of priority information 430 of the priority table 400 of the first electronic device 201. For example, the first processor 220a may classify the data types 410 according to transmission levels such as high, mid (i.e., middle), and low on the basis of at least a portion of the priority information 430 of the priority table 400 of the first electronic device 201.

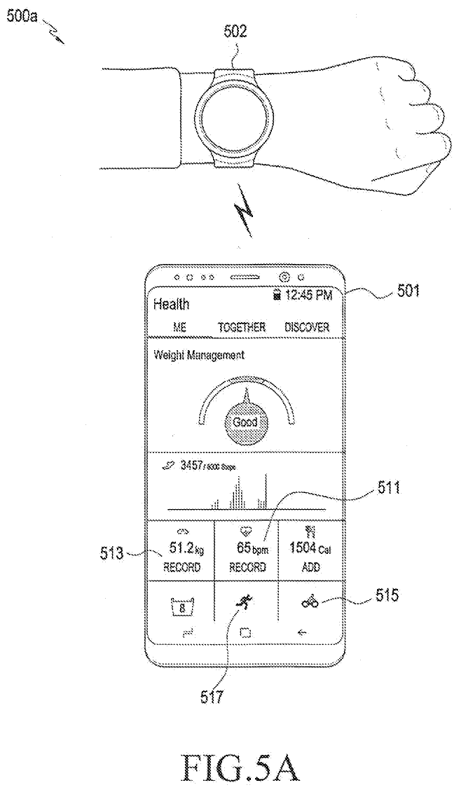

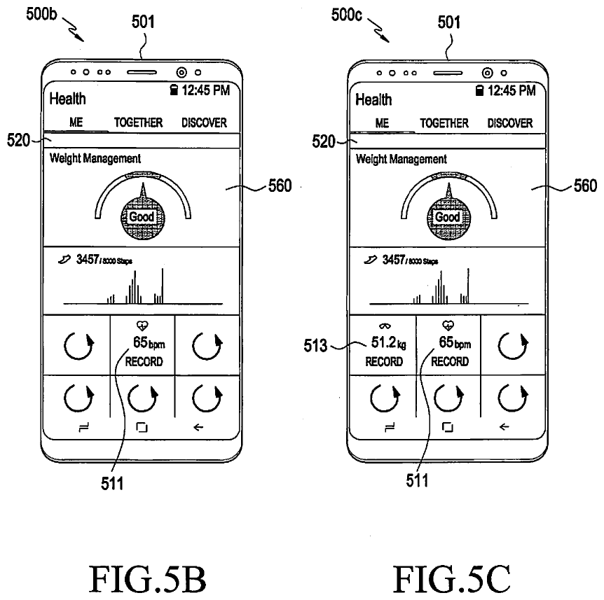

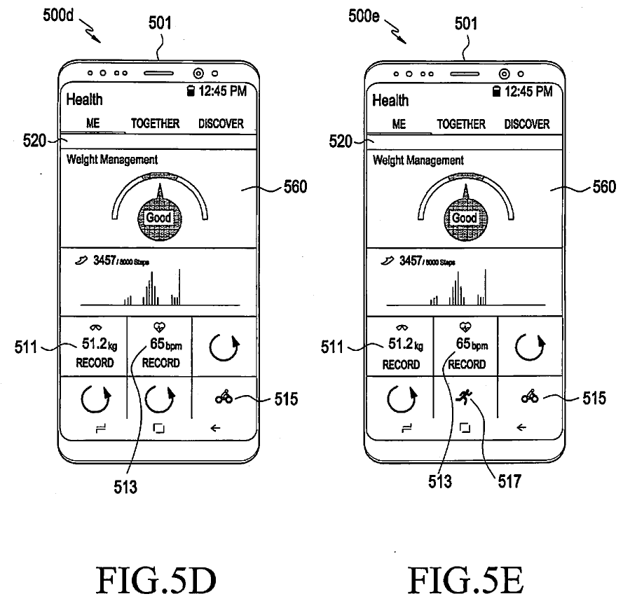

The first processor 220a may display data received from the second electronic device 202 that was transmitted on the basis of at least a portion of the priority table 400 of the first electronic device 201. The first processor 220a may sequentially update the data based on an order in which the data was received from the second electronic device 202, and display the data on a first display 260a. In FIGS. 5A to 5E, an operation of displaying received data according to the priority will be described.

FIG. 5A is a diagram 500a illustrating an operation of displaying data in an electronic device, according to an embodiment; FIG. 5B is a diagram 500b illustrating an operation of displaying data in an electronic device according to an embodiment; FIG. 5C is a diagram 500c illustrating an operation of displaying data in an electronic device according to an embodiment; FIG. 5D is a diagram 500d illustrating an operation of displaying data in an electronic device according to an embodiment; and FIG. 5E is a diagram 500e illustrating an operation of displaying data in an electronic device according to an embodiment.

FIG. 5A illustrates an operation in which a second electronic device 502 receives a priority table of a first electronic device 501 including priorities of heart rate data 511, weight data 513, exercise (cycle) data 515, and exercise (i.e., walking) data 517 transmitted from the first electronic device 501. The second electronic device 502 may be a wearable device and may sequentially transmit the heart rate data, the weight data, the exercise (cycle) data, and the exercise (walking) data among biometric data measured by the second electronic device 502 to the first electronic device 501 on the basis of at least a portion of the received priority table of the first electronic device 501.

As illustrated in FIG. 5B, the first electronic device 501 receives heart rate data corresponding to the highest priority from the second electronic device 502 and displays the heart rate data in a predetermined area 511 for displaying the heart rate data on a first display 560 for displaying execution of a health application. Alternatively, when the first electronic device 501 receives the heart rate data from the second electronic device 502, the first electronic device 501 may display notification information indicating synchronization of the heart rate data. For example, the first electronic device 501 may display “synchronizing heart rate data from the wearable device”, received from the second electronic device 502, in a predetermined area 520 for the notification information on the first display 560.

As illustrated in FIG. 5C, the first electronic device 501 may receive weight data corresponding to the next priority (i.e., the second highest priority value) from the second electronic device 502 and display the weight data in a predetermined area 513 for displaying the weight data on the first display 560 for displaying execution of the health application. Alternatively, when the first electronic device 501 receives the weight data from the second electronic device 502, the first electronic device 501 may display notification information indicating synchronization of the weight data. For example, the first electronic device 501 may display “synchronizing weight data from the wearable device”, received from the second electronic device 502, in the predetermined area 520 for the notification information on the first display 560.

As illustrated in FIG. 5D, the first electronic device 501 may receive exercise (cycle) data corresponding to the next (i.e., second highest, third highest, fourth highest, etc.) priority from the second electronic device 502 and display the exercise (cycle) data in a predetermined area 515 for displaying the exercise (cycle) data on the first display 560 for displaying execution of the health application. Alternatively, when the first electronic device 501 receives the exercise (cycle) data from the second electronic device 502, the first electronic device 501 may display notification information indicating synchronization of the exercise (cycle) data. For example, “synchronizing exercise (cycle) data from the wearable device”, received from the second electronic device 502, may be displayed in the predetermined area 520 for the notification information on the first display 560.

As illustrated in FIG. 5E, the first electronic device 501 may receive exercise (walking) data corresponding to the next priority (i.e., second highest, third highest, fourth highest, etc.) from the second electronic device 502 and display the exercise (walking) data in a predetermined area 517 for displaying the exercise (walking) data on the first display 560 for displaying execution of the health application. Alternatively, when the first electronic device 501 receives the exercise (walking) data from the second electronic device 502, the first electronic device 501 may display notification information indicating synchronization of the exercise (walking) data. For example, “synchronizing exercise (walking) data from the wearable device”, received from the second electronic device 502, may be displayed in the predetermined area 520 for the notification information on the first display 560. The first processor 220a may transmit information on data received from the second electronic device 202 to the server 108 on the basis of at least a portion of the priority table of the first electronic device 201.

The first memory 230a may store the priority table of the first electronic device 201 having priority information for each data type.

The first memory 230a may store the default priority table 300 corresponding to user profile information of the first electronic device 201, received from the server 108, as the priority table of the first electronic device 201.

The first memory 230a may store a personalized priority table 400 generated on the basis of at least a portion of the default priority table 300 corresponding to user profile information of the first electronic device 201 received from the server 108 and/or personal data stored in the first memory 230a.

The first display 260a (for example, the display device 160) may sequentially display data received from the second electronic device having received the priority table of the first electronic device 201.

The first sensor unit 276a (for example, the sensor module 176) may measure biometric data (for example, health data) through a biometric measurement.

The first sensor unit 276a may include an optical sensor for measuring heart rate, blood pressure, and blood sugar of the user and an electrode for measuring electrocardiogram (ECG) and arrhythmia. Further, the first sensor unit 276a may include an acceleration sensor for sensing and counting a user's activity (i.e., steps) or sleep, and also various sensors for sensing and measuring a user's activity such as a gyro sensor, a gas sensor, or an ultra-wideband (UWB) sensor.

The first communication unit 290a (for example, the communication module 190) may transmit and receive data through a communication connection with the server 108 or the second electronic device 202.

The first communication unit 290a may connect with the server 108 through a first network (for example, a long-range communication network such as a cellular network, Internet, a computer network (for example, LAN or WAN) or the network 199) and receive the default priority table 300 from the server 108 corresponding to user profile information of the first electronic device 201.

The first communication unit 290a may connect with the second electronic device 202 through a second network (for example, a short-range communication network such as Bluetooth, Wi-Fi direct, Infrared Data Association (IrDA), or through the first network 198), transmit the priority table of the first electronic device 201 to the second electronic device 202, and receive data from the second electronic device 202 on the basis of at least a portion of the priority table of the first electronic device 201.

The second electronic device 202 may include the second processor 220b, the second memory 230b, the second display 260b, the second sensor unit 270b, and the second communication unit 290b.

The second processor 220b may transmit data to the first electronic device 201 on the basis of at least a portion of the priority table of the first electronic device 201.

The second processor 220b may receive the priority table of the first electronic device 201 from the first electronic device 201 at the time point at which communication with the first electronic device 201 is established and store the received priority table.

The second processor 220b may identify priority information for each data type on the basis of at least a portion of the priority table of the first electronic device 201 received from the first electronic device 201 at the time point at which communication with the first electronic device 201 is established. The second processor 220b may transmit the type of biometric data (for example, health data) measured by the second electronic device 202 to the first electronic device 201 on the basis of at least a portion of the identified priority information.

The second processor 220b may identify a transmission level classified according to each data type on the basis of at least a portion of the priority table of the first electronic device 201.

The second processor 220b may transmit data through a first transmission scheme (for example, a serial transmission scheme) or a second transmission scheme (for example, a parallel transmission scheme) on the basis of an implementation type according to a structure of the electronic device and/or a stack layer structure.

When data transmission through the second transmission scheme is determined, the second processor 220b may sequentially transmit data to the first electronic device 201 in an order of priority on the basis of the transmission levels classified according the data type identified in the priority table of the first electronic device 201.

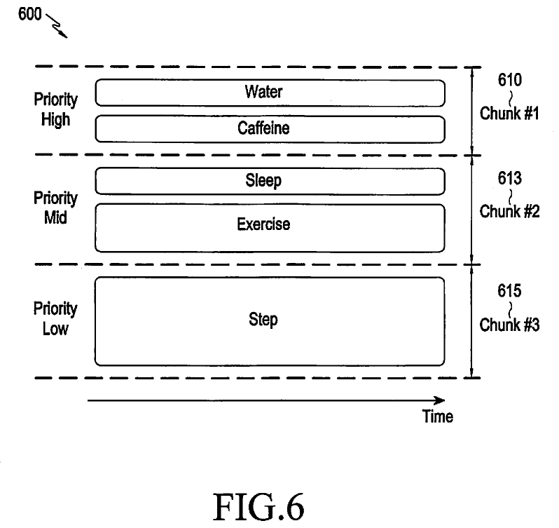

FIG. 6 is a diagram 600 illustrating an operation in which the electronic device transmits data, according to an embodiment. In FIG. 6, an operation is described in which the second electronic device 202 configures data chunks according to a type according to an order based on the highest priority (i.e., priority value) and transmits data through a request-response scheme.

Referring to FIG. 6, when the second processor 220b identifies that water data and caffeine data are classified as a high transmission level, sleep data and exercise data are classified as a mid transmission level, and step data is classified as a low transmission level on the basis of at least a portion of the priority table of the first electronic device 201, the second processor 22b may configure data into chunks in an order of transmission level corresponding to priority and transmit the data through a request-response scheme. When the second processor 220b transmits a first chunk 610 (chunk #1) corresponding to water data and caffeine data classified as the high transmission level to the first electronic device 201 and receives a response message for acknowledging reception of the first chunk 610 (chunk #1) from the first electronic device 201, the second processor 220b may transmit a second chunk 613 (chunk #2) corresponding to sleep data and exercise data classified as the mid transmission level to the first electronic device 201. When the second processor 220b receives a response message for acknowledging reception of the second chunk 613 (chunk #2) from the first electronic device 201, the second processor 220b may transmit a third chunk 615 (chunk #3) corresponding to step data classified as the low transmission level to the first electronic device 201 and receive a response message for acknowledging reception of the third chunk 615 (chunk #3) from the first electronic device 201.

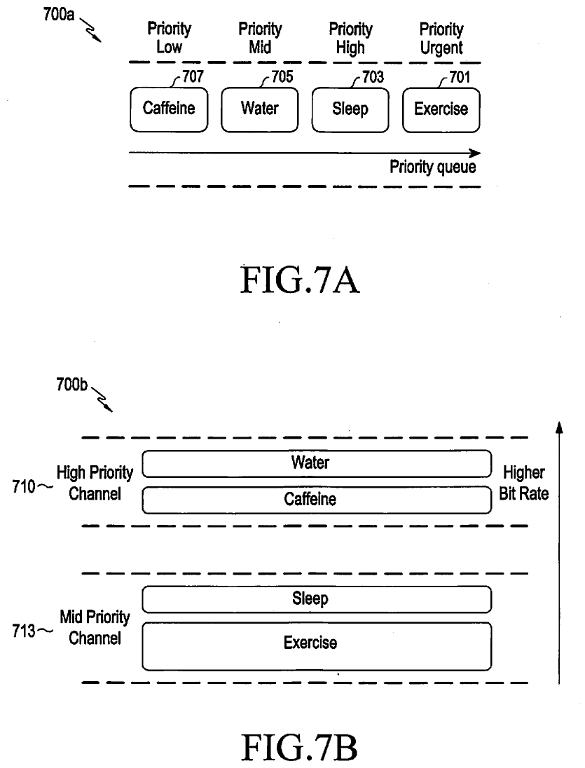

As illustrated in FIG. 6, the scheme for configuring the chunks according to the data type based on an order according to priority (i.e., highest priority) and transmitting data through the request-response scheme may include a first transmission scheme (for example, serial transmission scheme) and a second transmission scheme (for example, parallel transmission scheme). In FIGS. 7A and 7B, the first transmission scheme and the second transmission scheme will be described.

FIG. 7A is a diagram 700a illustrating an operation in which the electronic device transmits data, according to an embodiment. FIG. 7B is a diagram 700b illustrating an operation in which the electronic device transmits data, according to an embodiment. FIGS. 7A and 7B illustrate an operation in which the second electronic device 202 transmits data through the first transmission scheme and the second transmission scheme by way of example.

The first transmission scheme and the second transmission scheme may configure data chunks according to data type in an order based on a highest priority, and transmit each piece of data in the order based on the highest priority.

Referring to FIG. 7A, when data transmission through the first transmission scheme is determined, the second processor 220b may insert data into a priority queue in the order based on the highest priority and transmit the data.

When the second processor 220b identifies that exercise data 701 is classified as an urgent transmission level, sleep data 703 is classified as a high transmission level, water data 705 is classified as a mid transmission level, and caffeine data 707 is classified as a low transmission level on the basis of at least a portion of the priority table of the first electronic device 201, the second processor 220b may insert the exercise data 701, the sleep data 703, the water data 705, and the caffeine data 707 into a priority queue in an order based on the transmission level corresponding to a priority (i.e., a priority value) and transmit the data to the first electronic device 201.

Referring to FIG. 7B, when data transmission through the second transmission scheme is determined, the second processor 220b may transmit data to the first electronic device 201 in an order based on the highest priority on the basis of the transmission levels classified according to the data type identified in the priority table of the first electronic device 201. In the case of the second transmission scheme, data may be transmitted through a communication means corresponding to the transmission level of data among a plurality of communication means. The plurality of communication means may include a plurality of channels. Among the plurality of separated channels (for example, socket, ipc, or binder), a channel having a high bit rate or a high permission may transmit data having a high priority. Further, the plurality of communication means may include physical communication means. The physical communication means (for example, Bluetooth, Bluetooth low energy (BLE), a cellular network, or Wi-Fi) may be classified according to a priority to transmit data. Temporary data unrelated to security, such as health data or medical data, normal data, or a thumbnail image, may be classified as urgent, or having a high transmission level, and may be more rapidly transmitted through a normal channel (for example, a secure or non-secure channel).

When the second processor 220b identifies that water data and caffeine data are classified as a high transmission level and sleep data and exercise data are classified as a mid transmission level on the basis of at least a portion of the priority table of the first electronic device 201, the second processor 220b may transmit the water data and the caffeine data classified as the high transmission level through a first channel 710 having a high bit rate (a high priority channel) among a plurality of communication means, for example, a plurality of channels. The second processor 220b may transmit the sleep data and the exercise data classified as the mid transmission level through a second channel 713 (mid priority channel) having a lower bit rate than the first channel 710 among the plurality of channels.

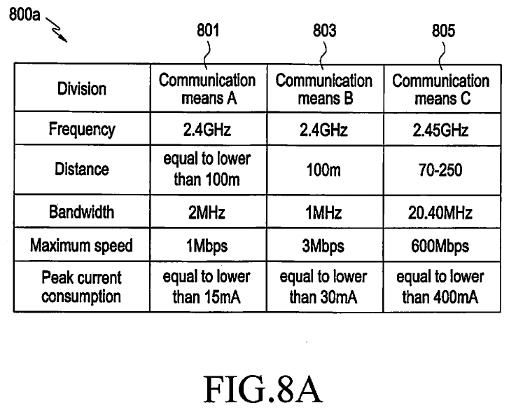

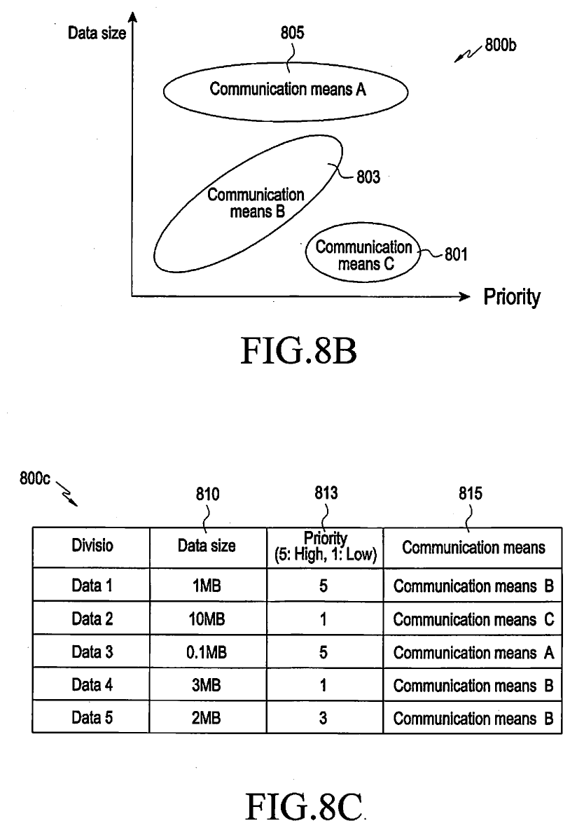

FIG. 8A is a diagram 800a illustrating a plurality of communication means through which the electronic device transmits data, according to an embodiment; FIG. 8B is a diagram 800b illustrating a plurality of communication means through which the electronic device transmits data, according to an embodiment; and FIG. 8C is a diagram 800c illustrating a plurality of communication means through which the electronic device transmits data, according to an embodiment. In FIGS. 8A to 8C, a plurality of communication means for transmitting data through the second transmission scheme (for example, parallel transmission scheme) are described.

As illustrated in FIG. 8A, a plurality of communication means 801, 803, and 805 may have different frequencies, distances, bandwidths, maximum speeds, and peak current consumption. The second processor 220b may determine a communication means for transmitting data according to a priority based on a characteristic of each communication means.

As illustrated in FIG. 8B, the second processor 220b may determine a communication means among communication means A 801, communication means B 803, and communication means C 805 according to a data priority and a data size.

As illustrated in FIG. 8C, the second processor 220b may determine a communication means 815 among a plurality of communication means on the basis of at least a portion of the data size 810 and the priority 813.

The second memory 230b may store the priority table of the first electronic device 201 having priority information for each data type.

The second memory 230b may store various pieces of biometric data (for example, exercise data, sleep data, and water data) measured using the second sensor unit 276b.

The second display 260b may display a function corresponding to the second electronic device 202.

The second display 260b may display various pieces of biometric data (for example, exercise data, sleep data, and water data) measured using the second sensor unit 276b.

According to various embodiments, the second sensor unit 276b may measure biometric data (for example, exercise, sleep data, and water data) through biometric measurement.

The second sensor unit 276b may include an optical sensor for measuring heart rate, blood pressure, and blood sugar of the user and an electronic device for measuring ECG and arrhythmia. Further, the second sensor unit 276b may include an acceleration sensor for sensing and counting a user's activity or sleep, a gyro sensor, a gas sensor, and/or a UWB sensor.

The second communication unit 290b may transmit and receive data through a communication connection with the server 108 or the first electronic device 201.

The second communication unit 290b may connect with the server 108 through a first network (for example, a long-range communication network such as a cellular network, Internet, or a computer network (for example, LAN or WAN)).

The second communication unit 290b may connect with the first electronic device 201 through a second network (for example, a long-range communication network such as Bluetooth, Wi-Fi direct, or IrDA), receive the priority table of the first electronic device 201 from the first electronic device 201, and transmit data to the first electronic device 201 on the basis of at least a portion of the priority table of the first electronic device.

When the first electronic device 201 transmits the priority table of the first electronic device 201 to the second electronic device 202, the second electronic device 202 may transmit data to the first electronic device 201 on the basis of at least the portion of the priority table of the first electronic device 201 with respect to biometric data measured by the second electronic device 202, but when the second electronic device 202 transmits the priority table of the second electronic device 202 to the first electronic device 201, the first electronic device 201 may perform the same operation of transmitting data to the second electronic device 201 on the basis of at least the portion of the priority table of the second electronic device 202 with respect to biometric data measured by the first electronic device 201.

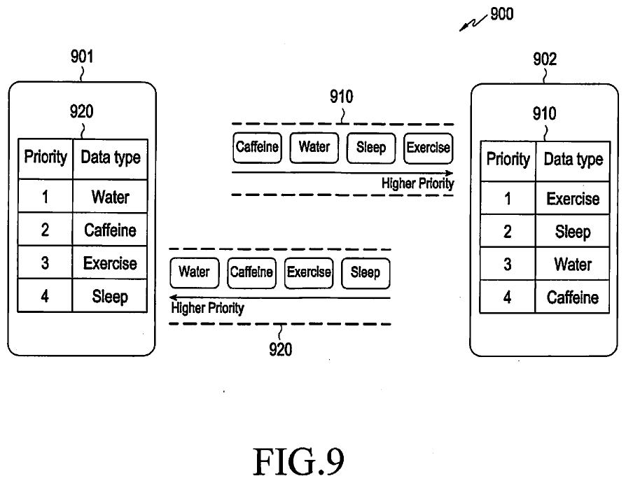

FIG. 9 is a diagram 900 illustrating an operation in which electronic devices exchange priority tables, according to an embodiment.

Referring to FIG. 9, a first electronic device 901 configures exercise data as data having a high priority and a second electronic device 902 configures water data as data having a high priority. The first electronic device 901 and the second electronic device 902 may exchange their priority tables at a time point at which communication between the first electronic device 901 and the second electronic device 902 is established.

When the first electronic device 901 transmits a priority table 910 of the first electronic device to the second electronic device 902 at the time point at which communication between the first electronic device 901 and the second electronic device 902 is established, the second electronic device 901 may change the priority table 910 of the first electronic device into the priority table of the second electronic device 902 in order to transmit data to the first electronic device 901 on the basis of at least a portion of the priority table 910 of the first electronic device while the communication connection with the first electronic device 901 is established.

The second electronic device 902 may transmit data to the first electronic device 901 on the basis of at least a portion of the priority table of the second electronic device 902 corresponding to the priority table 910 of the first electronic device while the second electronic device 902 is connected to the first electronic device 901. When the communication connection between the first electronic device 901 and the second electronic device 902 is cancelled, the second electronic device 902 may change the priority table of the second electronic device 902 to the priority table before the communication connection with the first electronic device 901 was established rather than to the priority table 910 of the first electronic device. When the second electronic device 902 transmits the priority table 920 of the second electronic device to the first electronic device 901 at the time point at which the communication between the first electronic device 901 and the second electronic device 902 is established, the first electronic device 901 may change the priority table 920 of the second electronic device into the priority table of the first electronic device 901 in order to transmit data on the basis of at least a portion of the priority table of the second electronic device 902 while the second electronic device 902 is connected with the first electronic device 901.

The first electronic device 901 may transmit data to the second electronic device 902 on the basis of at least the portion of the priority table of the first electronic device 901 corresponding to the priority table 920 of the second electronic device while the first electronic device 901 is connected to the second electronic device 902. When the communication connection between the first electronic device 901 and the second electronic device 902 is cancelled, the first electronic device 901 may change the priority table of the first electronic device 901 to the priority table before the communication connection with the second electronic device 902 is established rather than to the priority table 920 of the second electronic device.

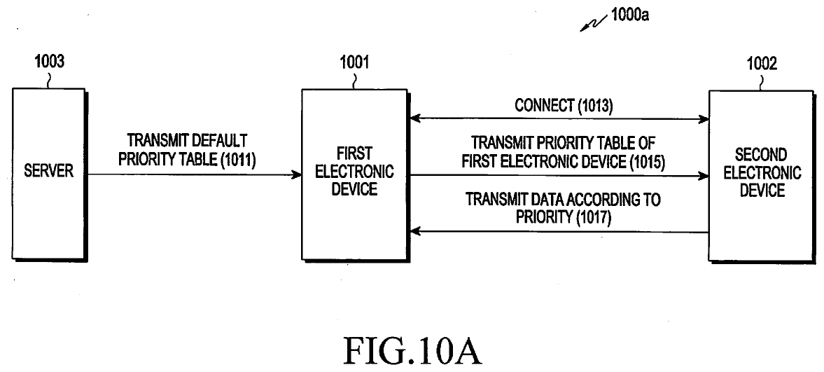

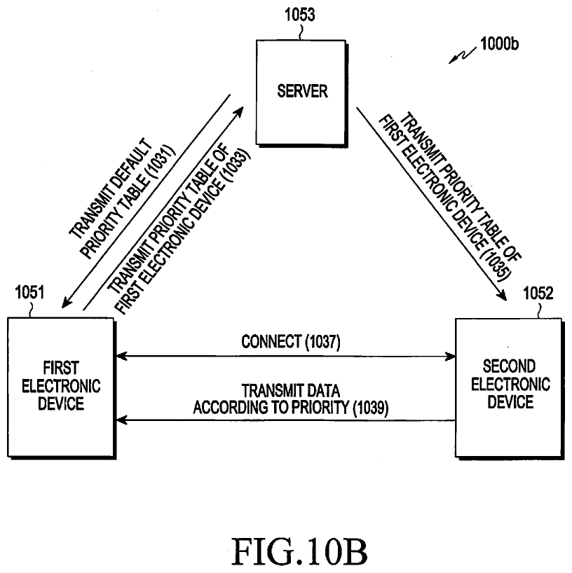

FIG. 10A is a diagram 1000a illustrating an operation in which the electronic device transmits data according to the priority, according to an embodiment. FIG. 10B is a diagram 1000b illustrating an operation in which the electronic device transmits data according to the priority, according to an embodiment.

Referring to FIG. 10A, an external server 1003 transmits a default priority table corresponding to user profile information of the first electronic device 1001 among a plurality of priority tables to the first electronic device 1001 in step 1011. The first electronic device 1001 may receive a default priority table having priority information for each data type from the server 1003 and configure the received default priority table as the priority table of the first electronic device 1001. Alternatively, the first electronic device 1001 may generate a personalized priority table on the basis of at least a portion of the received default priority table and/or personal data stored in the first electronic device 1001 and configure the generated personalized priority table as the priority table of the first electronic device 1001. When communication with the second electronic device 1002 is established in step 1013, the first electronic device 1001 transmits the priority table of the first electronic device 1001 to the second electronic device 1002 in step 1015.

The second electronic device 1002 may sequentially transmit various pieces of biometric information stored in or measured by the second electronic device 1002 on the basis of at least a portion of the received priority table of the first electronic device. The first electronic device 1001 may sequentially update and display the data received from the second electronic device 1002.

Referring to FIG. 10B, an external server 1053 transmits a default priority table corresponding to user profile information of the first electronic device 1051 among a plurality of priority tables to the first electronic device 1051 in step 1031. The first electronic device 1051 may receive a default priority table having priority information for each data type from the server 1053 and configure the received default priority table as the priority table of the first electronic device 1051. Alternatively, the first electronic device 1051 may generate a personalized priority table on the basis of at least a portion of the received default priority table and/or personal data stored in the first electronic device 1051 and configure the generated personalized priority table as the priority table of the first electronic device 1051. The first electronic device 1051 transmits the priority table (for example, a newly configured default priority table or the personalized priority table) of the first electronic device 1051 to the server 1053 in step 1033.

Upon receiving the priority table of the first electronic device 1051 from the first electronic device 1051, the server 1053 may store the priority table of the first electronic device 1051 on the basis of a user account of the first electronic device 1051.

The server 1053 identifies a second electronic device 1052 registered as an electronic device associated with the first electronic device 1051 and transmits the priority table of the first electronic device 1051 to the second electronic device 1052 periodically, whenever the priority table of the first electronic device 1051 is updated, or according to a request from the second electronic device 1052 in step 1035. Upon receiving priority information of the first electronic device 1051 from the server 1053, the second electronic device 1052 may store the received priority information of the first electronic device 1051.

When communication with the first electronic device 1051 is established in step 1037, the second electronic device 1052 sequentially transmits various pieces of biometric information stored in or measured by the second electronic device 1052 to the first electronic device 1051 on the basis of at least a portion of the priority table of the first electronic device 1051 received from the server 1053 in step 1039. The first electronic device 1051 may sequentially update and display the data received from the second electronic device 1052.

According to various embodiments, an electronic device may include a housing, a touch screen display exposed through a portion of the housing, at least one communication module located inside the housing, a processor located inside the housing and operatively connected to the touch screen display and the at least one communication module; and a memory located inside the housing and operatively connected to the processor, wherein the memory is configured to store at least one of personal data and a priority table having priority information of each data type, and store instructions causing the processor, when executed, to establish a connection with an external electronic device by the electronic device through the communication module, transmit the priority table of the electronic device to the external electronic device in response to the established connection, and receive data transmitted through the communication module from the external electronic device based on at least a portion of the priority table of the electronic device.

The instructions may be configured to cause the processor to receive a default priority table corresponding to user profile information of the electronic device among a plurality of priority tables from an external server through the communication module and configure the received default priority table as the priority table of the electronic device.

The instructions may be configured to cause the processor to periodically receive the default priority table from the external server through the communication module and update the priority table of the electronic device based on at least a portion of the received default priority table.

The instructions may be configured to cause the processor to generate a personalized priority table based on at least a portion of the default priority table received from the external server and/or personal data stored in the electronic device in response to a selection of generation of the personalized priority table and configure the generated personalized priority table as the priority table of the electronic device.

The instructions may be configured to cause the processor to update the priority table of the electronic device corresponding to the personalized priority table based on at least a portion of a change of the personal data stored in the electronic device.

The instructions may be configured to cause the processor to configure the default priority table as the priority table of the electronic device in response to a selection of cancelling generating the personalized priority table in a state in which the personalized priority table is configured as the priority table of the electronic device.

The instructions may be configured to cause the processor to classify types of the data according to a transmission level based on at least a portion of priority information in the priority table of the electronic device.

The instructions may be configured to cause the processor to display the data on the touch screen display based on at least a portion of an order of the data received from the external electronic device.

The instructions may be configured to cause the processor to receive a priority table of the external electronic device from the external electronic device through the communication module, identify a priority of each data type based on at least a portion of the received priority table, and transmit the data to the external electronic device based on at least a portion of the identified priority.

The instructions may be configured to cause the processor to transmit the data to the external electronic device in an order corresponding to a highest priority based on at least a portion of the priority table of the external electronic device when a data transmission scheme is a first transmission scheme, and identify a transmission level of the data type based on at least a portion of the priority table of the external electronic device and transmit the data through a communication means corresponding to the identified transmission level among a plurality of communication means when the data transmission scheme is a second transmission scheme.

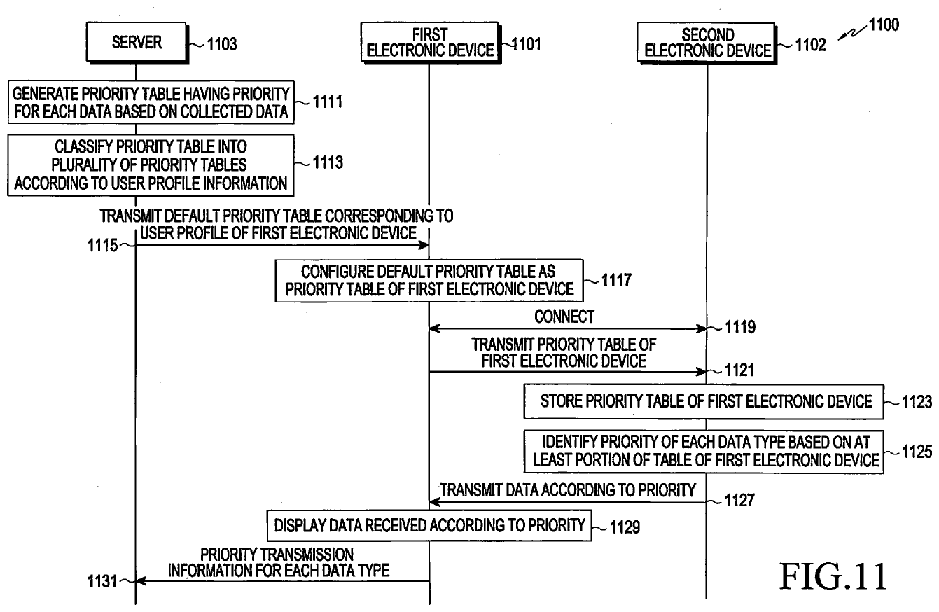

FIG. 11 is a flowchart 1100 illustrating a data transmission operation of the electronic device, according to an embodiment.

In step 1111, a server 1103 generates a priority table having priority information for each data type on the basis of at least a portion of data collected from a plurality of electronic devices.

In step 1113, the server 1103 classifies the generated priority table into a plurality of priority tables according to user profile information (for example, age, gender, and weight).

In step 1115, the server 1103 transmits a default priority table corresponding to profile information of the first electronic device among the plurality of priority tables to a first electronic device 1101.

In step 1117, the first electronic device 1101 stores the default priority table received from the server 1103 and configures the default priority table received from the server 1103 as a priority table of the first electronic device 1101.

When the first electronic device 1101 is connected to a second electronic device 1102 in step 1119, the first electronic device 1101 transmits the priority table of the first electronic device 1101 to the second electronic device 1102 in step 1121.

In step 1123, the second electronic device 1102 stores the priority table of the first electronic device 1101 received from the first electronic device 1101.

In step 1125, the second electronic device 1102 identifies a priority of each data type on the basis of at least a portion of the priority table of the first electronic device 1101.

In step 1127, the second electronic device 1102 sequentially transmits various pieces of biometric data (for example, exercise data, sleep data, and water data) measured by and stored in the second electronic device 1102 on the basis of at least a portion of the priority table of the first electronic device 1101 to the first electronic device 1101 sequentially in an order of priority.

In step 1129, the first electronic device 1101 displays data received from the second electronic device 1102 that was sequentially transmitted based on at least a portion of the priority table of the first electronic device 1101.

In step 1131, the first electronic device 1101 transmits priority transmission information for each data type received from the second electronic device 1102 to the server 1103 in order to update the plurality of priority tables of the server 1103.

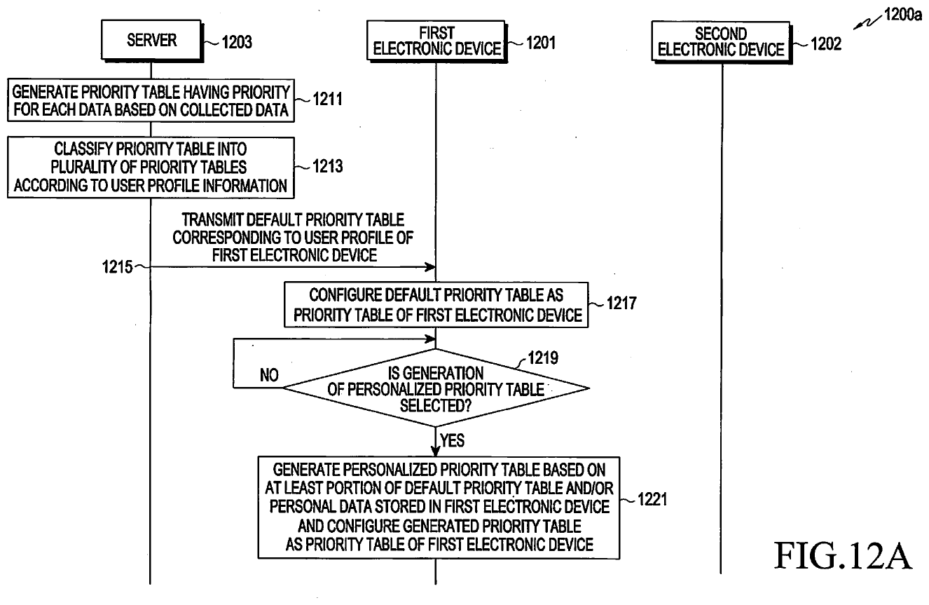

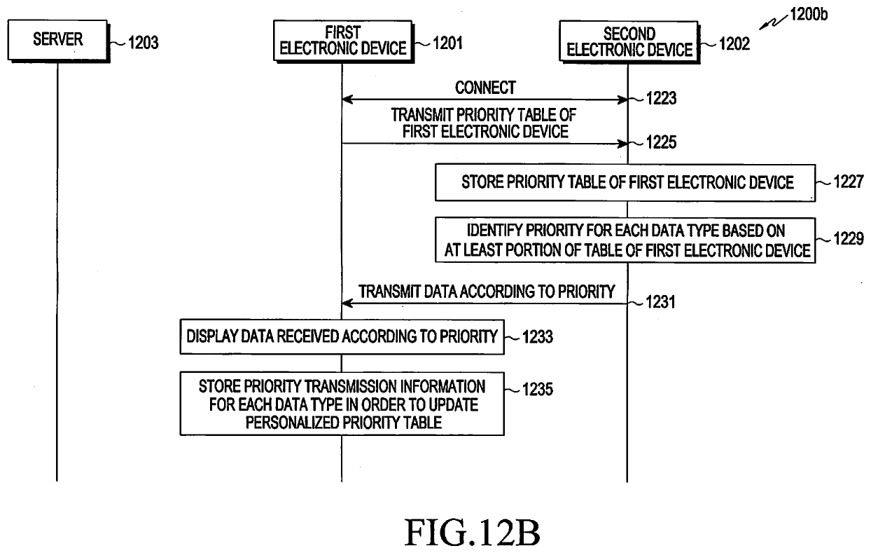

FIG. 12A is a flowchart 1200a illustrating a data transmission operation of the electronic device, according to an embodiment. FIG. 12B is a flowchart 1200b illustrating a data transmission operation of the electronic device, according to an embodiment.

In step 1211, a server 1203 generates a priority table having priority information for each data type on the basis of at least a portion of data collected from a plurality of electronic devices.

In step 1213, the server 1203 classifies the generated priority table into a plurality of priority tables according to user profile information (for example, age, gender, and weight).

In step 1215, the server 1203 transmits a default priority table corresponding to profile information of the first electronic device 1201 among the plurality of priority tables to the first electronic device 1201.

In step 1217, the first electronic device 1201 stores the default priority table received from the server 1203 and configures the default priority table received from the server 1203 as a priority table of the first electronic device 1201.

Upon receiving a selection of a personalized priority table in step 1219, the first electronic device 1201 generates the personalized priority table on the basis of at least a portion of the default priority table received from the server 1203 and/or personal data stored in the first electronic device 1201 in step 1221. The first electronic device 1201 may generate a personalized priority table in which the priority of each data type is changed from that of the default priority table on the basis of at least a portion of the personal data stored in the first electronic device 1201. The first electronic device 1201 may configure the generated personalized priority table as the priority table of the first electronic device 1201.

When the first electronic device 1201 is connected to a second electronic device 1202 through communication in step 1223, the first electronic device 1202 transmits the priority table of the first electronic device 1201 to the second electronic device 1202 in step 1225.

In step 1227, the second electronic device 1202 stores the priority table of the first electronic device 1201 received from the first electronic device 1201.

In step 1229, the second electronic device 1202 identifies a priority for each data type on the basis of at least a portion of the priority table of the first electronic device 1201.

In step 1231, the second electronic device 1202 sequentially transmits various pieces of biometric data (for example, exercise data, sleep data, and water data) measured by and stored in the second electronic device 1202 on the basis of at least a portion of the priority table of the first electronic device 1201 to the first electronic device 1201 sequentially in an order of priority.

In step 1233, the first electronic device 1201 displays data received from the second electronic device 1202 that was sequentially transmitted based on at least a portion of the priority table of the first electronic device 1201.

In step 1235, the first electronic device 1201 stores priority transmission information for each data type received from the second electronic device 1202 in the first electronic device 1201 as the personal data in order to update the personalized priority table configured as the priority table of the first electronic device 1201.

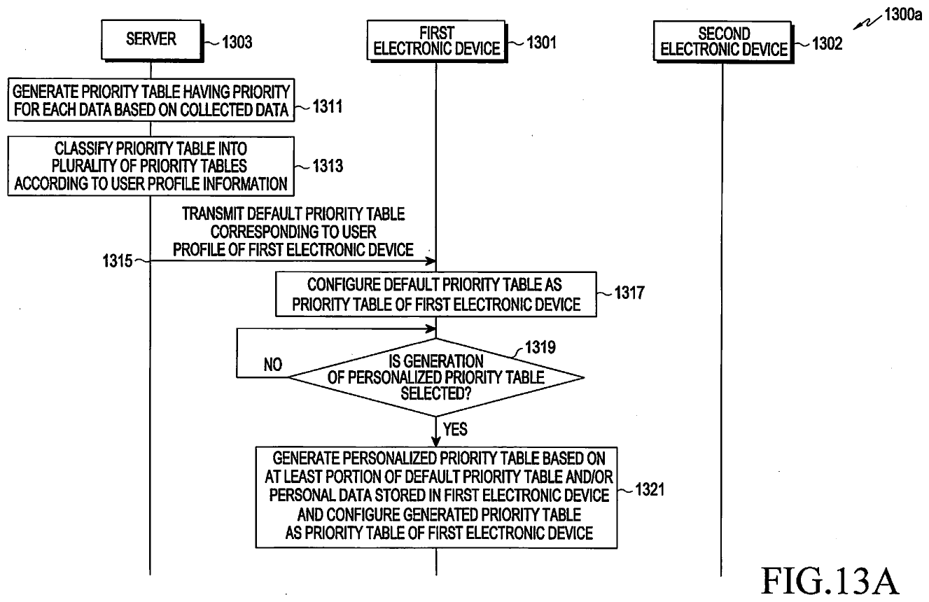

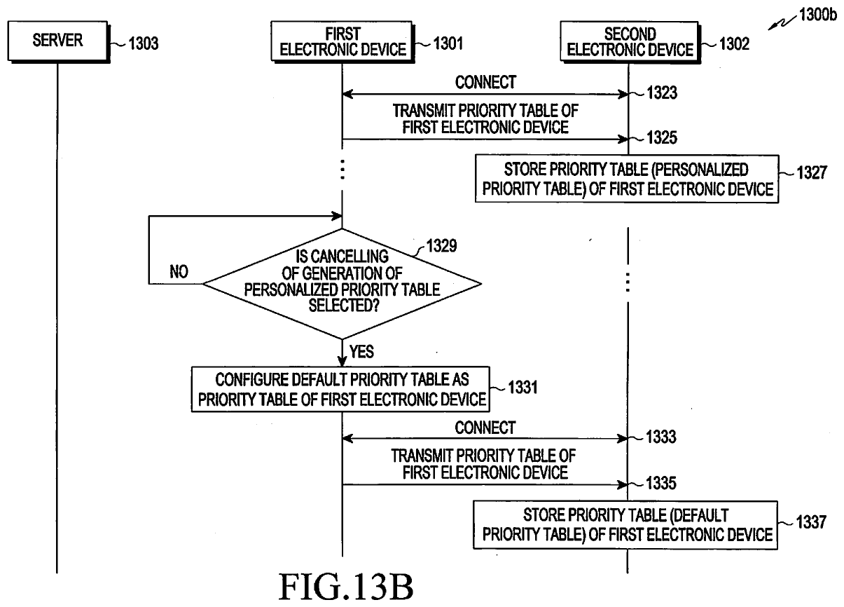

FIG. 13A is a flowchart 1300a illustrating a data transmission operation of the electronic device, according to an embodiment. FIG. 13B is a flowchart 1200b illustrating a data transmission operation of the electronic device, according to an embodiment.

In step 1311, a server 1303 generates a priority table having priority information for each data type on the basis of at least a portion of data collected from a plurality of electronic devices.

In step 1313, the server 1303 classifies the generated priority table into a plurality of priority tables according to user profile information (for example, age, gender, and weight).

In step 1315, the server 1303 transmits a default priority table corresponding to profile information of the first electronic device 1301 among the plurality of priority tables to a first electronic device 1301.

In step 1317, the first electronic device 1301 stores the default priority table received from the server 1303 and configures the default priority table received from the server 1303 as a priority table of the first electronic device 1301.

Upon receiving a selection of a personalized priority table in step 1319, the first electronic device 1301 generates the personalized priority table on the basis of at least a portion of the default priority table received from the server 1303 and/or personal data stored in the first electronic device 1301 in step 1321. The first electronic device 1301 generates a personalized priority table in which the priority of each data type is changed from that of the default priority table on the basis of at least a portion of the personal data stored in the first electronic device 1301. The first electronic device 1301 may configure the generated personalized priority table as the priority table of the first electronic device 1301.

When the first electronic device 1301 is connected to a second electronic device 1302 through communication in step 1323, the first electronic device 1301 transmits the priority table of the first electronic device 1301 to the second electronic device 1302 in step 1325.

In step 1327, the second electronic device 1302 stores the priority table of the first electronic device 1301 received from the first electronic device 1301. The second electronic device 1302 may identify a priority of each data type on the basis of at least a portion of the priority table of the first electronic device and sequentially transmits, in a priority order (i.e., based on priorities of each data type), various pieces of biometric data (for example, exercise data, sleep data, and water data) measured by and stored in the second electronic device 1302 on the basis of at least a portion of the priority table of the first electronic device 1301 to the first electronic device 1301.

Upon receiving a selection cancelling the generation of the personalized priority table in step 1329, the first electronic device 1301 configures the default priority table received from the server 1303 and stored in the first electronic device 1301 as the priority table of the first electronic device in step 1331.

When the first electronic device 1301 is connected to a second electronic device 1302 through communication in step 1333, the first electronic device 1301 transmits the priority table of the first electronic device 1301 to the second electronic device 1302 in step 1335.

In step 1337, the second electronic device 1302 stores the priority table of the first electronic device 1301 received from the first electronic device 1301. The second electronic device 1302 identifies a priority of each data type on the basis of at least a portion of the priority table of the first electronic device 1301 and sequentially transmits various pieces of biometric data (for example, exercise data, sleep data, and water data) measured by and stored in the second electronic device 1302 on the basis of at least a portion of the priority table of the first electronic device 1301 that was sequentially transmitted from the first electronic device 1301 in an order of priority (i.e., based on the priority of each data type).

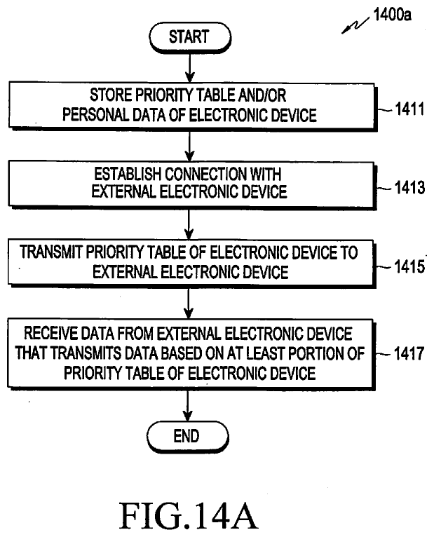

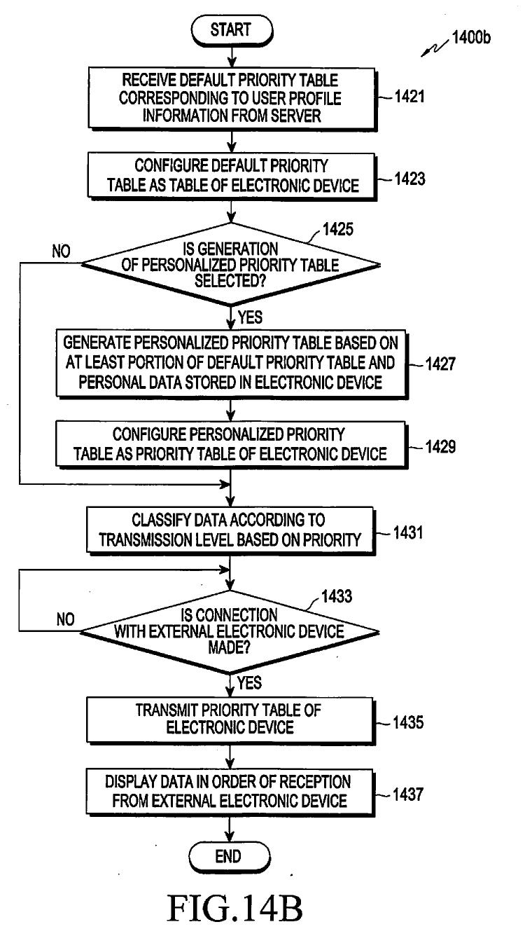

FIG. 14A is a flowchart 1400a illustrating a data transmission operation of the electronic device, according to an embodiment.

In step 1411, an electronic device 201 stores a priority table and/or personal data of the electronic device in a memory 230a. The priority table of the electronic device may be configured as a default priority table corresponding to user profile information of the electronic device 201 received from an external server 1003. The priority table of the electronic device 201 may be configured as a personalized priority table generated on the basis of at least a portion of the default priority table received from the server 1003 and/or personal data stored in the memory 230a of the electronic device 201. The personal data stored in the memory 230a may be a score (for example, the score of the priority determination data 320) for a frequency, visibility, and/or a file type corresponding to the data type used by the user of the electronic device 201.

In step 1413, the electronic device 201 establishes a communication connection with an external electronic device 202.

In step 1415, the electronic device 201 transmits the priority table of the electronic device 201 to the external electronic device 202.

In step 1417, the electronic device 201 receives data from the external electronic device 202 that was transmitted based on at least a portion of the priority table of the electronic device 201.

FIG. 14B is a flowchart 1400b illustrating a data transmission operation of the electronic device, according to an embodiment.

In step 1421, an electronic device 201 receives a default priority table corresponding to user profile information of the electronic device 201 from an external server 1003.

In step 1423, the electronic device 201 configures the default priority table received from the server as a priority table of the electronic device 201.

Upon receiving a personalized priority table in step 1425, the electronic device 201 generates the personalized priority table on the basis of at least a portion of the default priority table received from the server 1003 and/or personal data stored in the electronic device 201 in step 1427. The electronic device 201 may generate the personalized priority table in which the priority for each data type is changed from that of the default priority table on the basis of at least a portion of the personal data stored in the electronic device 201.

In step 1429, the electronic device 201 configures the generated personalized priority table as the priority table of the electronic device 201.

In step 1431, the electronic device 201 configures a transmission level of each data type on the basis of at least a portion of the priority information in the priority table of the electronic device 201. For example, the electronic device 201 may classify the data type into high, mid, and low transmission levels on the basis of at least a portion of the priority information.

Upon detecting a communication connection with an external electronic device 202 in step 1433, the electronic device 201 transmits the priority table of the electronic device 201 to the electronic device 201 in step 1435.

In step 1437, the electronic device 201 displays data sequentially received from the external electronic device 202 that was transmitted based on at least a portion of the priority table of the electronic device 201. The electronic device 201 may transmit priority information for each data type received from the external electronic device 202 to the server in order to update a plurality of priority tables of the server 1003. The electronic device 201 may store the priority transmission information for each data type received from the external electronic device 202 in the electronic device 201 as personal data in order to update the personalized priority table configured as the priority table of the electronic device 201.

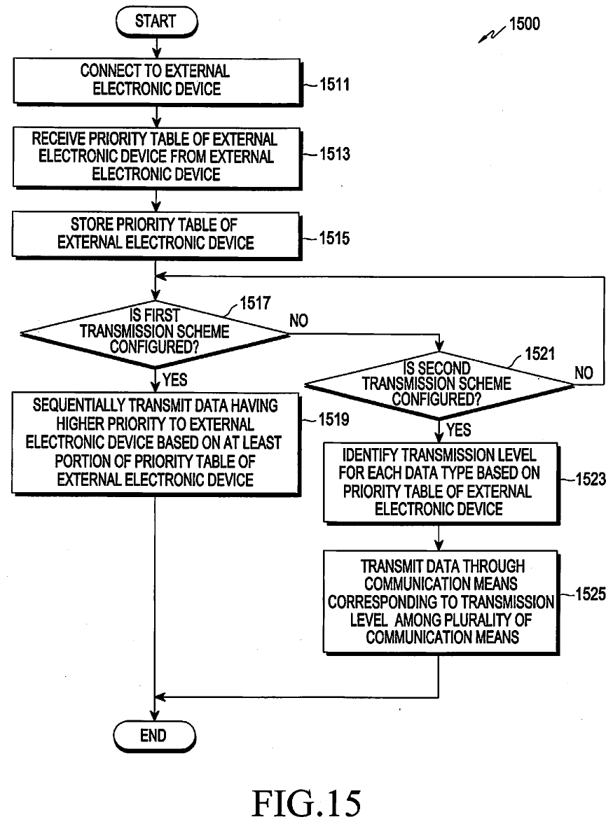

FIG. 15 is a flowchart 1500 illustrating a data transmission operation of the electronic device, according to an embodiment.

In step 1511, an electronic device 201 may establish a communication connection with an external electronic device 202.

At the time point at which the communication connection with the external electronic device 202 is established, the electronic device 201 receives a priority table of the external electronic device 202 from the external electronic device 202 in step 1513.

In step 1515, the electronic device 201 stores or updates the priority table of the external electronic device 202 received from the external electronic device 202 in the electronic device 201.

Upon determining that a data transmission scheme is configured as a first transmission scheme (for example, a serialized transmission scheme) in step 1517, the electronic device 201 sequentially transmits various pieces of biometric information (for example, exercise data, sleep data, or water data) measured by the electronic device 201 to the external electronic device 202 in an order of priority (i.e., initially transmitting data with the highest priority) on the basis of at least a portion of the priority table of the external electronic device 202 received from the external electronic device 202 in step 1519. The electronic device 201 may insert data into a priority queue based on the order of priority and transmit or classify the data into chunks based on the order of priority. The electronic device 201 may transmit the data through a request-response scheme.

Upon determining that the data transmission scheme is configured as a second transmission scheme (for example, a parallelized transmission scheme) in step 1521, the electronic device 201 identifies a transmission level of each data type on the basis of at least a portion of the priority table of the external electronic device 201 received from the external electronic device 202 in step 1523.

In step 1525, the electronic device 201 transmits data to the external electronic device 202 through a communication means corresponding the transmission level among a plurality of communication means on the basis of at least a portion of the transmission level for each of the data types identified in the priority table of the external electronic device 202. The plurality of communication means may include a plurality of channels, and the electronic device 202 may sequentially transmit data having a relatively high priority through the plurality of channels (for example, socket, inter-process communication (IPC), or binder) in an order based on a high bit rate or a high permission level. Alternatively, the plurality of communication means may include physical communication means, and the electronic device 201 may classify the physical communication means (for example, BT, BLE, a cellular network, or Wi-Fi) and transmit data based on an order of priority.

According to various embodiments, a method of transmitting data by an electronic device may include an operation of storing at least one of personal data and a priority table having priority information for each data type; an operation of establishing a connection with an external first electronic device by the electronic device; an operation of transmitting the priority table of the electronic device to the external first electronic device in response to the established connection; and an operation of receiving data from the external first electronic device that was transmitted based on at least a portion of the priority table of the electronic device.

The method may further include an operation of receiving a default priority table corresponding to user profile information of the electronic device among a plurality of priority tables from an external server and an operation of configuring the received default priority table as the priority table of the electronic device.

The method may further include an operation of periodically receiving the default priority table from the external server and an operation of updating the priority table of the electronic device based on at least a portion of the received default priority table.

The method may further include an operation of generating a personalized priority table based on at least a portion of the default priority table received from the external server and/or personal data stored in the electronic device in response to a selection of generation of the personalized priority table and an operation of configuring the generated personalized priority table as the priority table of the electronic device.

The method may further include an operation of updating the priority table of the electronic device corresponding to the personalized priority table based on at least a portion of a change of the personal data stored in the electronic device.

The method may further include an operation of configuring the default priority table as the priority table of the electronic device in response to a selection of cancelling generating the personalized priority table in a state in which the personalized priority table is configured as the priority table of the electronic device.

The method may further include an operation of classifying types of data according to a transmission level based on at least a portion of the priority information in the priority table of the electronic device.

The method may further include an operation of displaying the data on the touch screen display based on at least a portion of a sequential order of the data received from the external electronic device.

The method may further include an operation of receiving a priority table of the external electronic device from the external electronic device, an operation of identifying a priority of each data type based on at least a portion of the received priority table, and an operation of transmitting the data to the external electronic device based on at least a portion of the identified priority.

The operation of transmitting the data may include an operation of sequentially transmitting the data to the external electronic device in an order of priority (i.e., highest priority first) based on at least a portion of the priority table of the external electronic device when a data transmission scheme is a first transmission scheme and an operation of identifying a transmission level of the data type based on at least a portion of the priority table of the external electronic device and transmitting the data through a communication means corresponding to the identified transmission level among a plurality of communication means when the data transmission scheme is a second transmission scheme.

According to various embodiments, it is possible to provide optimized performance suitable for one or more users by providing a priority information table for data transmission of an individual user without transmitting data related to a client application and devices to all users on a network.

That is, characteristics of the devices occupied by the users may be considered based on an exchange of individual user priority information tables between devices occupied by the users. Additionally, a delay generated due to expansion of attribute information of the individual user priority information tables according to diversification of a communication channel with the biometric information measurement device may be minimized. In addition, performance may be increased by immediately updating a user interface (UI) or a graphic UI (GUI) upon receipt of health data which the user desires.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. An electronic device comprising:
a housing;
a touch screen display exposed through a portion of the housing;
at least one communication module located inside the housing;
a processor located inside the housing and operatively connected to the touch screen display and the at least one communication module; and
a memory located inside the housing and operatively connected to the processor,
wherein the memory is configured to store at least one of personal data and a priority table having priority information of each data type, and store instructions causing the processor, when executed, to:
establish a connection with an external electronic device by the electronic device through the communication module,
transmit the priority table of the electronic device to the external electronic device in response to the established connection, and
receive data transmitted from the external electronic device through the communication module based on at least a portion of the priority table of the electronic device.

2. The electronic device of claim 1, wherein the instructions are further configured to cause the processor to receive a default priority table corresponding to user profile information of the electronic device among a plurality of priority tables from an external server through the communication module and configure the received default priority table as the priority table of the electronic device.

3. The electronic device of claim 2, wherein the instructions are further configured to cause the processor to periodically receive the default priority table from the external server through the communication module and update the priority table of the electronic device based on at least a portion of the received default priority table.

4. The electronic device of claim 2, wherein the instructions are further configured to cause the processor to generate a personalized priority table based on at least a portion of the default priority table received from the external server and the personal data stored in the electronic device in response to a selection of generating the personalized priority table and configure the generated personalized priority table as the priority table of the electronic device.

5. The electronic device of claim 4, wherein the instructions are further configured to cause the processor to update the priority table of the electronic device corresponding to the personalized priority table based on at least a portion of a change of the personal data stored in the electronic device.

6. The electronic device of claim 4, wherein the instructions are further configured to cause the processor to configure the default priority table as the priority table of the electronic device in response to a selection of cancelling generating the personalized priority table in a state in which the personalized priority table is configured as the priority table of the electronic device.

7. The electronic device of claim 1, wherein the instructions are further configured to cause the processor to classify types of the received data according to a transmission level based on at least a portion of the priority information in the priority table of the electronic device.

8. The electronic device of claim 1, wherein the instructions are further configured to cause the processor to display the data on the touch screen display based on at least a portion of an order of the data received from the external electronic device.

9. The electronic device of claim 1, wherein the instructions are further configured to:
cause the processor to receive a priority table of the external electronic device from the external electronic device through the communication module,
identify a priority of each data type based on at least a portion of the received priority table, and
transmit the data to the external electronic device based on at least a portion of the identified priority.

10. The electronic device of claim 9, wherein the instructions are further configured to cause the processor to:
transmit the data to the external electronic device in an order of priority based on at least a portion of the priority table of the external electronic device when a data transmission scheme is a first transmission scheme, and
identify a transmission level of the data type based on at least a portion of the priority table of the external electronic device and transmit the data through a communication means corresponding to the identified transmission level among a plurality of communication means when the data transmission scheme is a second transmission scheme.

11. A method of transmitting data by an electronic device, the method comprising:
storing at least one of personal data and a priority table having priority information for each data type;
establishing a connection with an external electronic device by the electronic device;
transmitting the priority table of the electronic device to the external electronic device in response to the established connection; and
receiving data transmitted from the external electronic device based on at least a portion of the priority table of the electronic device.

12. The method of claim 11, further comprising receiving a default priority table corresponding to user profile information of the electronic device among a plurality of priority tables from an external server and configuring the received default priority table as the priority table of the electronic device.

13. The method of claim 12, further comprising:
periodically receiving the default priority table from the external server; and
updating the priority table of the electronic device based on at least a portion of the received default priority table.

14. The method of claim 12, further comprising:
generating a personalized priority table based on at least a portion of the default priority table received from the external server and the personal data stored in the electronic device in response to a selection of generating the personalized priority table; and
configuring the generated personalized priority table as the priority table of the electronic device.

15. The method of claim 14, further comprising updating the priority table of the electronic device corresponding to the personalized priority table based on at least a portion of a change of the personal data stored in the electronic device.

16. The method of claim 14, further comprising configuring the default priority table as the priority table of the electronic device in response to a selection of cancelling generating the personalized priority table in a state in which the personalized priority table is configured as the priority table of the electronic device.

17. The method of claim 11, further comprising classifying types of the received data according to a transmission level based on at least a portion of priority information in the priority table of the electronic device.

18. The method of claim 11, further comprising displaying the data on the touch screen display based on at least a portion of an order of the data received from the external electronic device.

19. The method of claim 11, further comprising:
receiving a priority table of the external electronic device from the external electronic device through the communication module;
identifying a priority of each data type based on at least a portion of the received priority table; and
transmitting the data to the external electronic device based on at least a portion of the identified priority.

20. The method of claim 19, wherein transmitting the data comprises:
transmitting the data to the external electronic device in an order of priority based on at least a portion of the priority table of the external electronic device when a data transmission scheme is a first transmission scheme; and
identifying a transmission level of the data type based on at least a portion of the priority table of the external electronic device and transmitting the data through a communication means corresponding to the identified transmission level among a plurality of communication means when the data transmission scheme is a second transmission scheme.
